(19) United States
(12) Patent Application Publication
(10) Pub. No.: US 2013/0024403 A1
(43) Pub. Date: Jan. 24, 2013

(54) AUTOMATICALLY INDUCED CLASS BASED SHRINKAGE FEATURES FOR TEXT CLASSIFICATION

(71) Applicants: STANLEY F. CHEN, PORT JEFFERSON, NY (US); RUHI SARIKAYA, SHRUB OAK, NY (US); STEPHEN M. CHU, ELMSFORD, NY (US); BHUVANA RAMABHADRAN, MOUNT KISCO, NY (US)

(72) Inventors: STANLEY F. CHEN, PORT JEFFERSON, NY (US); RUHI SARIKAYA, SHRUB OAK, NY (US); STEPHEN M. CHU, ELMSFORD, NY (US); BHUVANA RAMABHADRAN, MOUNT KISCO, NY (US)

(73) Assignee: INTERNATIONAL BUSINESS MACHINES CORPORATION, ARMONK, NY (US)

(21) Appl. No.: 13/189,028

(22) Filed: Jul. 22, 2011

(51) Int. Cl. G06F 15/18

(52) U.S. Cl. 706/12

(57) ABSTRACT

A method and apparatus are provided for automatically inducing class based shrinkage features. The method includes clustering each word in a set of word groupings of a given type into a respective one of a plurality of classes. The method further includes selecting and extracting a set of class-based shrinkage features from the set of word groupings based on the plurality of classes. The set of class-based shrinkage features is specifically selected for an intended classification application.

### BACKGROUND

1. Technical Field

The present invention generally relates to text classification and, more particularly, to automatically induced class based shrinkage features.

2. Description of the Related Art

Classifiers based on such machine learning methods as maximum entropy (MaxEnt), conditional random fields (CRFs), support vector machines (SVM), boosting (Boost) and neural network (NN) are trained using some amount of supervised or semi-supervised data.

A well-known problem relating to such classifiers is the natural language call routing application. In this application, speakers call telephone number to inquire about something. The automated assistant attempts to direct the user to one of N predefined classes (e.g., billing, address change, tech support, and so forth). These classes tend to be application specific. Typically, word based lexical features in the form of n-grams (typically uni-grams) are used to train the classifiers. Using higher order n-gram features may bring small, often insignificant, improvements to the text classification accuracy. It is believed that using additional information sources mentioned (e.g., syntactic, semantic, morphological, and so forth) above may improve the classification performance. However, imposing syntactic/semantic/morphological knowledge on the text to be classified requires training the parsers in the respective language and application. Even using a generic syntactic parser requires having access to manually annotated data to train the syntactic parser. Even though the training data and parsing engines are freely available to build reasonable parsers for English, it is often difficult to have the same for other languages. Therefore, lexical information in the form of words is often the only available source of information for text classification.

### SUMMARY

According to an aspect of the present principles, a method is provided. The method includes clustering each word in a set of word groupings of a given type into a respective one of a plurality of classes. The method further includes selecting and extracting a set of class-based shrinkage features from the set of word groupings based on the plurality of classes. The set of class-based shrinkage features is specifically selected for an intended classification application.

According to another aspect of the present principles, a system is provided. The system includes a word classifier for clustering each word in a set of word groupings of a given type into a respective one of a plurality of classes. The system further includes a shrinkage feature extractor for selecting and extracting a set of class-based shrinkage features from the set of word groupings based on the plurality of classes. The set of class-based shrinkage features are specifically selected for an intended classification application.

According to yet another aspect of the present principles, a computer readable storage medium is provided which includes a computer readable program that, when executed on a computer causes the computer to perform the respective steps of the aforementioned method.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary processing system 500 to which the present principles may be applied, according to an embodiment of the present principles;

FIG. 2 is a block diagram showing an exemplary system 200 for providing automatically induced class based shrinkage features for classifiers, in accordance with an embodiment of the present principles;

FIG. 3 is a flow diagram showing an exemplary method 300 for automatically extracting shrinkage features for text classification, according to an embodiment of the present principles;

FIG. 4 is a flow diagram showing an exemplary method 400 for performing clustering, according to an embodiment of the present principles;

FIG. 5 is a shallow clustering tree 500 for a shrinkage feature extraction to which the present principles may be applied, in accordance with an embodiment of the present principles; and

FIG. 6 is a deep clustering tree 600 for hierarchical shrinkage feature extraction to which the present principles may be applied, in accordance with an embodiment of the present principles.

### DETAILED DESCRIPTION OF PREFERRED EMBODIMENTS

As noted above, the present principles are directed to automatically induced class based shrinkage features. As used herein, shrinkage features refer to a set of word and class based features, which shrink the model size when they are used to train a model from the exponential family (e.g., Maximum Entropy, CRF, and so forth). More specifically, the shrinkage features are selected from the space of all the word n-grams, class n-gram and their joint features observed in a sentence. When these features are used to train an exponential model, the model size is shrunk as compared to models trained with others sets of features. While keeping the model performance on the training set the same, shrinking the model size results in improvement in test set performance.

We further note that machine learning methods such as those mentioned herein are quite flexible in integrating various overlapping information sources such as morphological, parsing, part-of-speech and topical. Hence, in accordance with the present principles, these information sources are treated as additional features, which are used to classify an utterance/paragraph/document (for the sake of simplicity, we use utterance for all hereinafter) into a number of predefined classes. As such, the shrinkage features obtained in accordance with the present principles advantageously improve the classification accuracy of classifiers employing the same.

As is appreciated by one of skill in the art, the present principles may be used for text classification, as well as other classification applications for different tasks. For example, such different tasks may include, but are not limited to, speech and audio classification, image classification, language modeling, gene sequencing, entity classification, and so forth. That is, the present principles can essentially be applied to any application where there is a classification task involved.

In accordance with the present principles, we design and automatically induce a set of features from plain text to be classified to improve the classification accuracy. These features are independent of the classifiers that are using them and are effective in, for example, all the above-mentioned machine learning classifiers. The goal of imposing some type of syntactic or semantic structure on an utterance is to model the high-level relationships between words. That is, such structure defines which words belong to the same high level hierarchical clusters (syntactic/semantic nodes) and what are the sequential relationships between these clusters. We believe that these relationships can be approximated by automatically clustering the words into a set of predefined classes at different levels (see, e.g., FIG. 6).

Thus, one exemplary problem addressed by the present principles is the introduction of new features for the plain text without the burdensome manual annotating associated therewith. In an accordance with one or more embodiments of the present principles, we can automatically induce new features from the plain text that are helpful for improving the classification performance without performing any manual annotation to train a statistical syntactic, semantic or morphological parser. Moreover, these features are selected so as to improve the classification accuracy.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

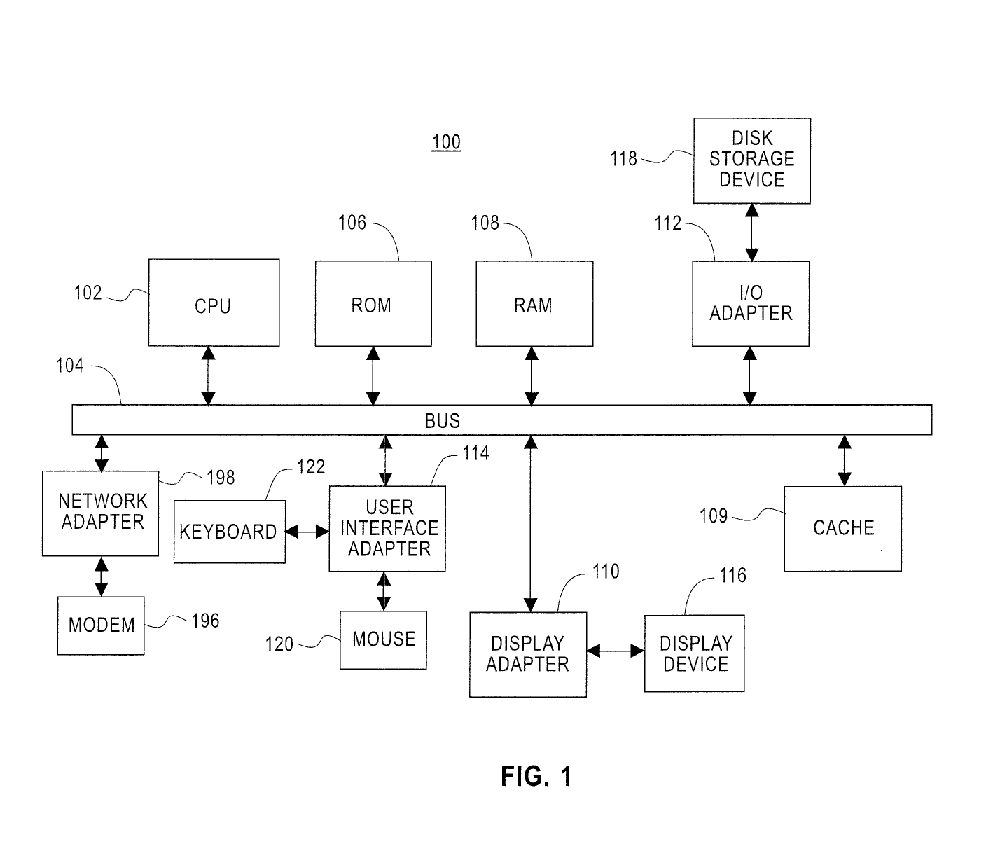

FIG. 1 shows an exemplary processing system 100 to which the present principles may be applied, according to an embodiment of the present principles. The processing system 100 includes at least one processor (CPU) 102 operatively coupled to other components via a system bus 104. A read only memory (ROM) 106, a random access memory (RAM) 108, a display adapter 110, an I/O adapter 112, a user interface adapter 114, and a network adapter 198, are operatively coupled to the system bus 104.

A display device 116 is operatively coupled to system bus 104 by display adapter 110. A disk storage device (e.g., a magnetic or optical disk storage device) 118 is operatively coupled to system bus 104 by I/O adapter 112.

A mouse 120 and keyboard 122 are operatively coupled to system bus 104 by user interface adapter 114. The mouse 120 and keyboard 122 are used to input and output information to and from system 100.

A (digital and/or analog) modem 196 is operatively coupled to system bus 104 by network adapter 198.

Of course, the processing system 100 may also include other elements (not shown), including, but not limited to, a sound adapter and corresponding speaker(s), and so forth, as readily contemplated by one of skill in the art.

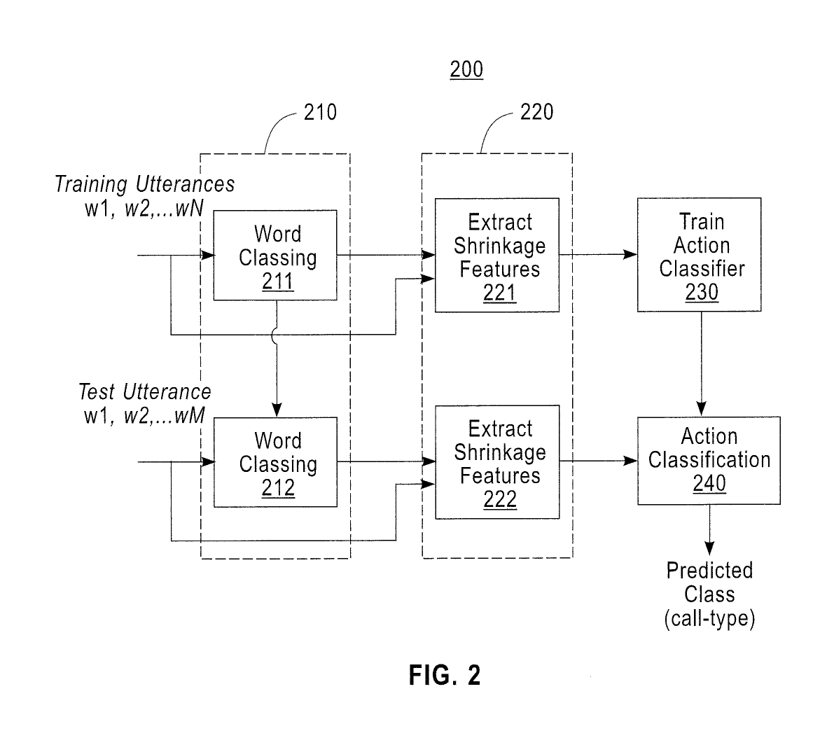

FIG. 2 shows an exemplary system 200 for providing automatically induced class based shrinkage features for classifiers, in accordance with an embodiment of the present principles. The system 200 includes a word classifier 210, a shrinkage features extractor 220, an action classifier trainer 230, and an action classifier 240.

For illustrative purposes, we will describe the word classifier 210 as having a first word classifier 211 for processing training utterances and then using these clusters (i.e. classes) for classing the words in the test utterances using a second word classifier 212, and will describe the shrinkage features extractor 220 as having a first shrinkage features extractor 221 for processing the training utterances and a second shrinkage features extractor 222 for processing the test utterances. However, it is to be appreciated that a single word classifier and a single shrinkage features extractor may be used, with each of the preceding elements processing both types of utterances. Moreover, it is to be appreciated that the second word classifier 212 may simply perform a look up on the data obtained by the first word classifier 211.

The first word classifier 211 has an output connected in signal communication with a first input of the first shrinkage features extractor 221. An output of the first shrinkage features extractor 221 is connected in signal communication with input of the action classifier trainer 230.

The second word classifier 212 has an output connected in signal communication with a first input of the second shrinkage features extractor 222. An output of the second shrinkage features extractor 2221 is connected in signal communication with input of the action classifier 240.

An input of the first word classifier 211 and a second input of the first shrinkage features extractor 221 are available as inputs to the system 200, for receiving the training utterances. As an example, a training utterance may be a sentence having words w1, w2, . . . , wN. An input of the second word classifier 212 and a second input of the second shrinkage features extractor 222 are available as inputs to the system 200, for receiving the test utterances. As an example, a test utterance may be a sentence having words w1, w2, . . . , w3. An output of the action classifier 240 is available as an output of the system 200, for outputting a predicted class (i.e., a predicted call-type (in call routing)).

The functions of the elements of system 200 will be described in further detail hereinafter.

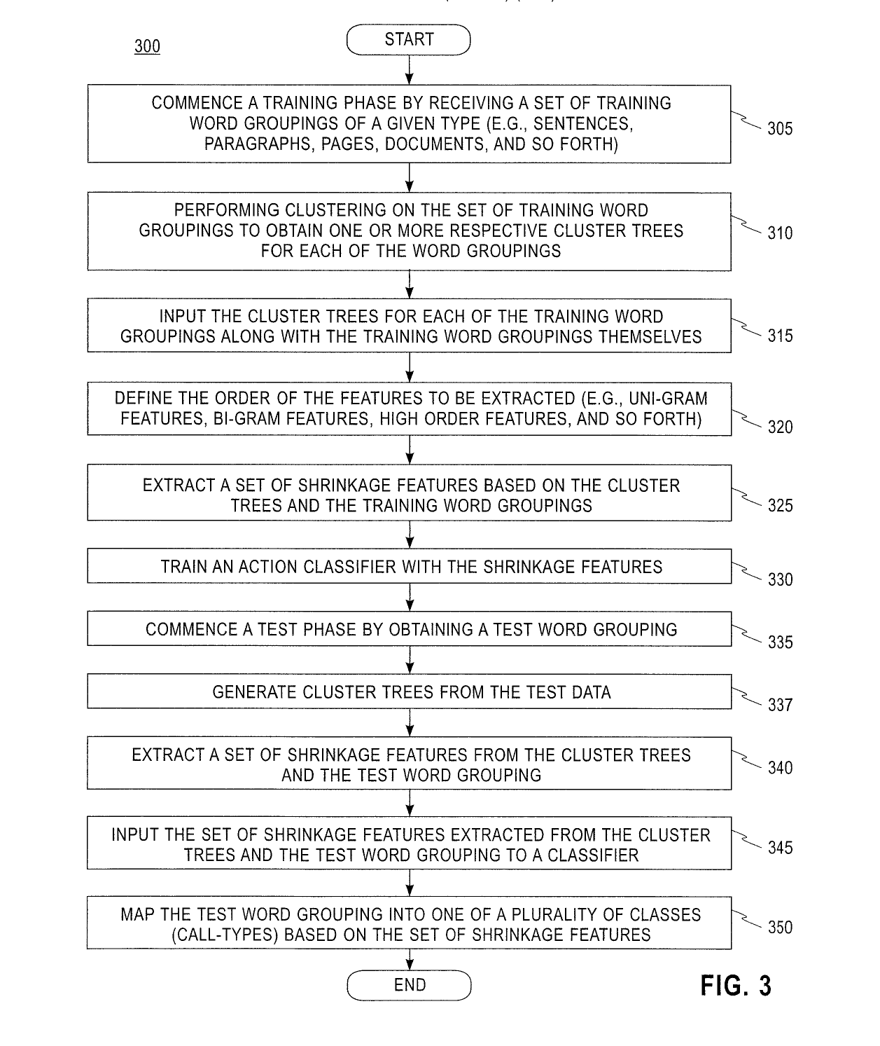

FIG. 3 shows an exemplary method 300 for automatically extracting and using shrinkage based features for class-based text classification, according to an embodiment of the present principles. At step 305, a training phase commences with the word classifier 210 receiving a set of training word groupings of a given type. The training word groupings may correspond to, for example, but are not limited to, sentences, paragraphs, pages, documents, and so forth.

At step 310, the word classifier 210 performs clustering of the words in the set of training word groupings to obtain a plurality of clusters/classes. The clustering can be, for example, but is not limited to, shallow clustering or deep clustering.

We note that clusters are interchangeably referred to herein as “classes”. Moreover, we note that, in an embodiment, the classes are automatically assigned based on the lexical information essentially assigning words into different the clusters. Words which are used in the same manner or context are typically put into the same clusters. For example, “Monday” and “Tuesday” or any other days of the week are put into the same cluster. This done in an unsupervised fashion, where the word clustering algorithm looks at the patterns in which the words are used in similar context and puts certain words in the same cluster. Note that each and every word is assigned to a cluster. The words which are in the same cluster share syntactic, semantic and/or functional similarity in terms of their usage in the sentences. Of course, other information (if available) such as syntactic, semantic or prior domain knowledge (for example if the data is from a financial domain we can put all the stock names, or financial local area network (LAN) names into the same cluster), may be used in addition to or in place of lexical information for the purpose of assigning the classes to the words in the set of word groupings. For example, days of the week may be automatically assigned to one class, similar meaning words (e.g., cancel and delete) may be automatically assigned to another class, digits may be automatically assigned to yet another class, and so forth.

At step 315, the plurality of classes along with the set of training word groupings themselves (received at step 305) are input to the shrinkage feature extractor 220.

At step 320, the order of the features to be extracted is defined. For example, one or more users may define the order (i.e., uni-gram, bi-gram, and so forth) of the features, or the order may be pre-defined. In an embodiment, the features may be defined as uni-gram features, bi-gram features, tri-gram features, high order features, and so forth.

At step 325, the shrinkage feature extractor 220 extracts a set of shrinkage features that relate to an intended classification application, based on the plurality of classes and the training word groupings. For example, TABLE 1 shows a particular list for the uni-gram and bi-gram case for shallow clustering. In an embodiment, the shrinkage features may be sum-based class features. By word clustering (as per step 310), we essentially identify groups of features (words) which will tend to have similar model parameters in terms of their magnitudes. For each such feature group, we add a new feature to the model (as per step 325) that is the sum of the original features. Given this perspective, we can explain why back-off features improve n-gram model performance.

For simplicity, consider a bigram model, one without unigram back-off features, namely p(w_j|w_{j−1}). In such a model, the sum feature would be the unigram feature, p(w_j), which is obtained by summing p(w_j|w_{j−1} over the history, w_{j−1}. The features given in TABLE 1 are derived with this intuition, basically defining class based features by summing over predicted words, w_j, or by summing over one or more of the history words, w_{j−1} and w_{j−2}.

At step 330, we train an action classifier (e.g., such as a call-type classifier) with the set of shrinkage features. The classifier can be, but is not limited to, SVM, CRF, MaxEnt, NNet, Boosting, or a combination thereof.

At step 335, the test phase (i.e., action classification) commences by obtaining a test word grouping. Similar to the training word grouping, the test word grouping may correspond to, for example, but is not limited to, a sentence, a paragraph, a document, and so forth. The test word grouping can be obtained from, but is not limited to, a speech recognition output, and so forth.

At step 337, we generate cluster trees for the test data.

At step 340, another set of shrinkage features are extracted from the cluster trees and the test word grouping by the shrinkage feature extractor 220. At step 345, the other set of shrinkage features are input to the action classifier 240. At step 350, the action classifier 240 maps the test word grouping into one of the plurality of classes (i.e., call-types) based on the other set of shrinkage features.

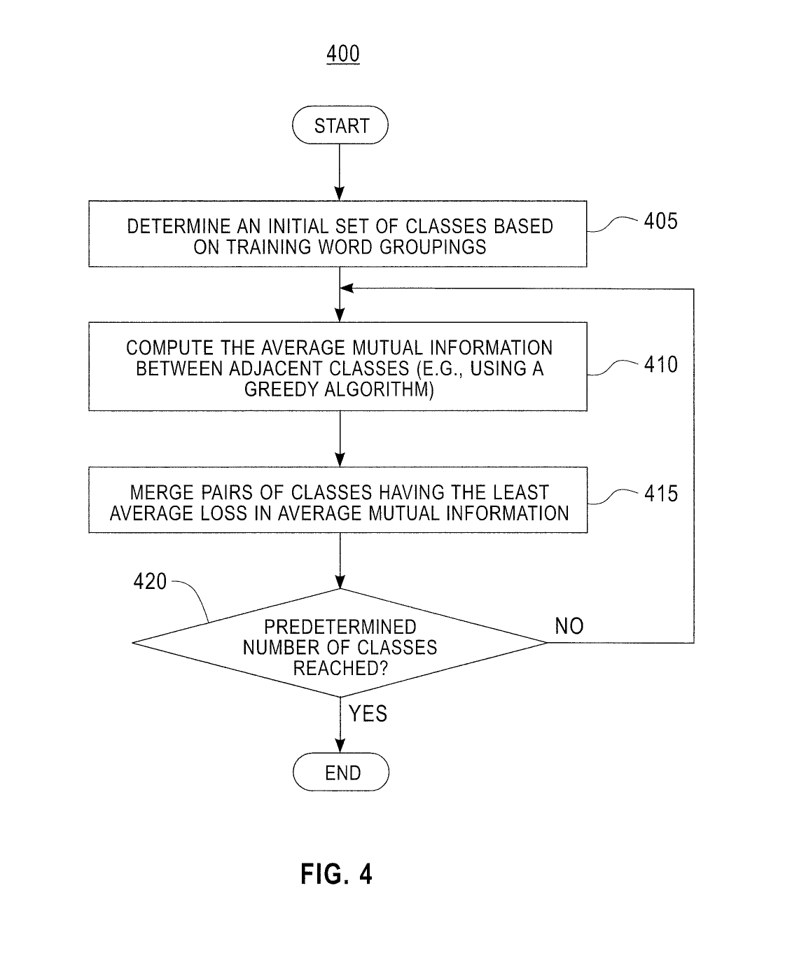

FIG. 4 shows a method 400 for clustering words in a set of word groupings, in accordance with an embodiment of the present principles. The method 400 corresponds to step 310 of method 300 of FIG. 3. At step 405, an initial set of classes is determined based on the training word groupings. Such determination may be based on, for example, but is not limited to, lexical n-gram features (e.g., uni-gram features, bi-gram features, tri-gram features, higher-order features, and so forth) present in the set of word groupings. Initially, each word is assigned to its own class. So there are as many classes as the words in the vocabulary of the training data. At step 410, the average mutual information between adjacent classes of the initial set is computed. It is to be appreciated that step 410 may involve, but is not limited to, the use of a greedy algorithm. As is known, a greedy algorithm find a locally optimal choice at each stage (e.g., in a set of stages to be performed) with the intent of finding the global optimum choice. At step 415, pairs of adjacent classes having the least average loss in mutual information are merged. At step 420, it is determined whether a predetermined number of classes has been reached, where the predetermined number of classes includes fewer classes than the initial set of classes. If so, then the method is terminated. Otherwise, method iteratively repeats steps 410 through 415 until the predetermined number of classes is reached. The remaining classes after the merging corresponding to the predetermined number of classes are the classes that are input to the shrinkage feature extractor at step 315.

Clustering

For illustrative purposes, the present principles as described herein consider two forms of clustering: (i) deep tree clustering; and (ii) shallow clustering. Of course, it is to be appreciated that the present principles are not limited to solely the preceding two types of clustering and, thus, other types of clustering may be used in accordance with the teachings of the present principles, while maintaining the spirit of the same.

Regarding deep tree clustering, the same can be obtained either via hierarchical clustering in a first approach or via applying shallow clustering at multiple layers in a second approach. The first approach operates on the original data, while the second approach uses the original data only to find the first level clusters, and then treats the first level cluster sequence as the data and clusters them to generate second level classes. The same process can be repeated as many times as the depth of the tree.

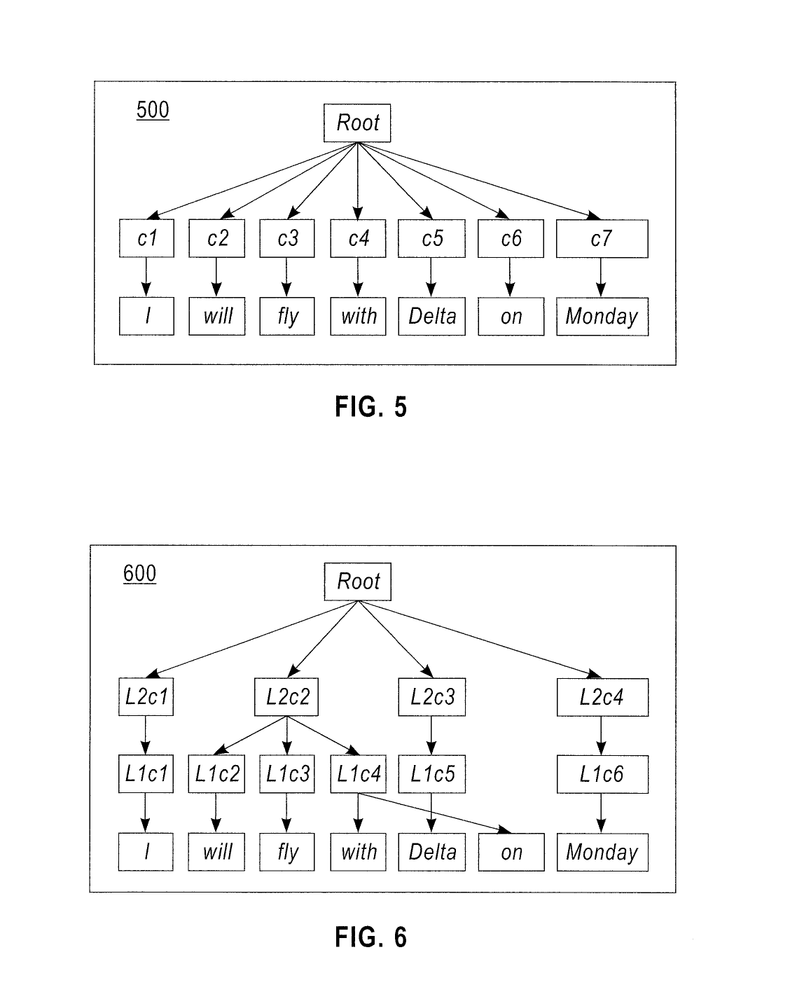

Regarding shallow clustering, we can use any clustering method but in one particular embodiment we consider using IBM clustering, which is based on the bi-gram mutual information between word classes. The IBM clustering algorithm collects the word bi-gram counts from the corpus and partitions the vocabulary into a specified number of classes to maximize the bi-gram mutual information between classes. The IBM clustering algorithm starts by assigning each word to a distinct class and computes the average mutual information between adjacent classes using a greedy algorithm. Pairs of classes with the least average loss in mutual information loss are merged. This process is repeated until the predetermined number of classes is reached. FIG. 5 shows an example of a shallow clustering tree 500 for a shrinkage feature extraction to which the present principles may be applied, in accordance with an embodiment of the present principles. The tree is obtained from the utterance “I will fly with Delta on Monday”. The clustering algorithm assigns each word to a class. In the example, different classes (i.e., clusters) are represented by “cN”, where N is an integer. In the example, N=7, as there are seven classes, namely c1 through c7. In the example, the word “Delta” is assigned to class c5, and the words “with” and “on’ are assigned to the same class (i.e., class c4).

FIG. 6 shows an example of a deep clustering tree 600 for hierarchical shrinkage feature extraction to which the present principles may be applied, in accordance with an embodiment of the present principles. In the example of FIG. 6, we show a two-level clustering where at the lowest level we have the following utterance “I will fly with Delta on Monday”. The clustering algorithm assigns each word to a class. For example, “L1c5” is the class assigned to the word “Delta”. L1 stands for Level-1 and c5 is the class 5 at L1. Therefore, the clustering is level dependent. Typically, the number of classes is much less than the number of words. Level 2 (L2) clustering treats the L1 clusters as individual items to be clustered (i.e., to be assigned as class). Thus, the number of classes in L2 is much less than the number of classes in L1. We empirically observed that words that are used in a similar context tend to get assigned to the same clusters. For example, other days of the week (Sunday, Saturday, Friday, and so forth) are assigned the same class tag L1c6. At the second level, a coarser clustering has done. For example, the classes (L1c2, L1c4) for function words (will, with and on) are assigned to the same class (L1c2).

Shrinkage Based Features

In an embodiment, the features we extract from the automatically induced parse tree are inspired from Model M features. Model M augments the traditional lexical n-gram features with the sum based class features. That is, Model M is a class-based n-gram model that can be viewed as the result of shrinking an exponential word n-gram model using word classes. However, while we describe the use of Model M features, the present principles are not limited to the same and, thus, other types of features may also be used while maintaining the spirit of the present principles.

Regarding the extraction, we note that the same can be performed at single or multiple levels. TABLE 1 shows the class based features for a single layer of classing, in accordance with an embodiment of the present principles. We note that the 2-gram features include the 1-gram features as a subset.

TABLE 1

| | |
|---|---|
| 1 gr features | c_j, w_j, c_jw_j |
| 2 gr FeatSetA | c_j, c_{j − 1}c_j, w_{j − 1}c_j, w_j, c_jw_j, |
| | w_{j − 1}w_j |
| 2 gr FeatSetB | c_j, c_{j − 1}c_j, w_{j − 1}c_j, w_j, |
| | w_{j − 1}c_jw_j, c_jw_j |
| 2 gr FeatSetC | c_j, c_{j − 1}c_j, w_j, c_jw_j, w_{j − 1}w_j |
| 2 gr FeatSetD | c_j, c_{j − 1}c_j, w_j, c_jw_j, w_{j − 1}w_jc_j |

In the example of TABLE 1, one set of uni-gram shrinkage features have been extracted, and four sets (A through D) of bi-gram shrinkage features have been extracted. In TABLE 1, “c” denotes a particular class, “w” denotes a particular word, and “j” denotes the jth position of the word in a sentence.

Thus, in the case of the uni-gram (“1 gr”) features, “c_j” denotes the jth class, “w_j” denotes the jth word from the jth class, and “c_jw_j” denotes a joint feature pertaining to the jth class and the jth word. An example of a joint feature is [DAYS_Monday] or [MONTHS_January] where DAYS and MONTHS are automatically discovered by the clustering algorithms, which puts all days into one class, c_j (c_j may denote DAYS cluster). Thus, the uni-gram features include a particular class (c_j) (e.g. DAYS), a particular word in that class (w_j) (e.g. TUESDAY), and a particular joint feature pertaining to both that word and that class (c_jw_j) (e.g. DAYS,Tuesday).

Moreover, as noted above, each set of bi-gram features includes the aforementioned uni-gram features. Regarding the first set of bi-gram features, designated “2 gr FeatSetA” in TABLE 1, the following bi-gram features are included in addition to the uni-gram features: “c_{j−1}c_j” denotes the (jth−1) class (i.e., the class before the jth class), “w{j−1}c_j” denotes the (jth−1 word) in the (jth−1) class; and “w{j−1}w_j” denotes the (jth−1) word followed by the jth word.

The other feature sets (i.e. FeatSetB, FeatSetC and FeatSetD) are obtained by minor modifications to the FeatSetA. For example, FeatSetB is obtained making the following change: [w_{j−1}w_j→w_{j−1}c_jw_j]. We note that given the alphabetically ordered identification of, for example, a jth word from a jth class, namely w_j, it is presumed that the number of classes is at least up to a “‘class j” and the number of word in that class j is at least up to “word j”, as would be readily appreciated by one of ordinary skill in this and related arts.

We performed a serious of experiments demonstrating the superior performance of the proposed features over baseline n-gram based features for text classification in a natural language call-routing application. TABLE 2 shows the action classification accuracy for MaxEnt (using baseline lexical features) and MaxEntM (using shrinkage based features) for a package shipment application, in accordance with an embodiment of the present principles.

TABLE 2
Action Classification Accuracy for MaxEnt and MaxEntM

| | 1 gr Features | | 2 gr | 2 gr FeatSetA | 2 gr FeatSetB | 2 gr FeatSetC | 2 gr FeatSetD |
|---|---|---|---|---|---|---|---|
| Data | MaxEntBase | MaxEntM | MaxEntBase | MaxEntM | | | |
| 1K | 76.0 | 76.6 | 75.7 | 76.1 | 76.2 | 76.7 | 76.6 |
| 2K | 80.4 | 81.0 | 79.8 | 79.9 | 80.0 | 80.4 | 80.6 |
| 3K | 82.2 | 82.8 | 82.0 | 82.9 | 82.3 | 83.6 | 82.9 |
| 4K | 83.5 | 84.3 | 83.1 | 83.6 | 83.6 | 84.1 | 84.1 |
| 5K | 84.6 | 85.1 | 84.6 | 84.8 | 85.0 | 85.3 | 85.2 |
| 6K | 85.5 | 86.3 | 85.4 | 85.8 | 85.8 | 86.1 | 85.9 |
| 7K | 86.2 | 86.5 | 86.0 | 86.2 | 86.2 | 86.5 | 86.3 |
| 8K | 86.5 | 86.8 | 86.6 | 87.2 | 87.2 | 87.4 | 87.2 |
| 9K | 87.2 | 87.7 | 87.3 | 87.7 | 87.6 | 87.8 | 87.8 |
| 10K | 87.6 | 87.8 | 87.5 | 87.7 | 87.7 | 88.1 | 87.6 |
| 15K | 88.7 | 89.1 | 88.6 | 88.8 | 88.9 | 89.3 | 89. |
| 20K | 89.6 | 89.7 | 89.5 | 89.5 | 89.9 | 90.2 | 90.0 |
| 27K | 89.7 | 89.8 | 90.3 | 90.6 | 90.4 | 90.5 | 90.7 |

TABLE 3 shows the action classification accuracy for MaxEnt and MaxEntM for a financial transaction task, in accordance with an embodiment of the present principles.

TABLE 3
Action Classification Accuracy for MaxEnt and MaxEntM

| | 1 gr Features | | 2 gr | 2 gr FeatSetA | 2 gr FeatSetB | 2 gr FeatSetC | 2 gr FeatSetD |
|---|---|---|---|---|---|---|---|
| Data | MaxEntBase | MaxEntM | MaxEntBase | MaxEntM | | | |
| 1K | 73.9 | 74.4 | 73.8 | 75.7 | 75.0 | 75.5 | 75.4 |
| 2K | 75.9 | 78.4 | 76.7 | 78.6 | 78.4 | 79.0 | 79.1 |
| 3K | 77.6 | 80.3 | 79.4 | 80.6 | 79.8 | 80.7 | 79.6 |
| 5K | 78.8 | 82.8 | 81.1 | 84.0 | 83.6 | 84.4 | 82.8 |
| 10K | 81.5 | 82.9 | 83.5 | 85.4 | 85.0 | 85.5 | 84.9 |
| 15K | 84.3 | 83.0 | 84.8 | 86.3 | 86.3 | 86.3 | 86.2 |
| 25K | 83.1 | 84.9 | 85.8 | 86.7 | 86.2 | 86.6 | 86.4 |
| 51K | 81.7 | 86.8 | 86.9 | 87.3 | 87.2 | 87.3 | 87.0 |

In both the shipment application example of TABLE 2 and the financial transaction task example of TABLE 3, uni-gram and bi-gram features are used. We observe significant and consistent gains with the proposed shrinkage based features on both tasks. The best gains are observed with FeatSetC.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method, comprising:
clustering each word in a set of word groupings of a given type into a respective one of a plurality of classes; and
selecting and extracting a set of class-based shrinkage features from the set of word groupings based on the plurality of classes,
wherein the set of class-based shrinkage features is specifically selected for an intended classification application.

2. The method of claim 1, wherein the given type comprises one of a sentence, a paragraph, a page, and a document.

3. The method of claim 1, wherein said clustering step clusters each word in the set of word groupings based on lexical n-gram features determined from the set of word groupings.

4. The method of claim 3, wherein the set of class-based shrinkage features comprises sum-based class features derived from the lexical n-gram features.

5. The method of claim 1, wherein said clustering step comprises hierarchical clustering.

6. The method of claim 5, wherein said clustering step is performed on the set of word groupings to obtain a plurality of first level clusters for each word in the set of word groupings, and is then further performed on the plurality of first level clusters or one or more pluralities of higher level clusters to obtain the plurality of clusters from which the shrinkage features are extracted.

7. The method of claim 1, wherein said clustering step initially clusters each word in the set of word groupings into a respective one of a larger set of clusters that is reduced to become the plurality of clusters, wherein the larger set of clusters is reduced by:
computing an average mutual information between adjacent ones of the larger plurality of classes,
merging the adjacent ones of the larger plurality of classes having a least average loss of the average mutual information there between,
wherein the computing and merging steps are repeated until only a predetermined number of classes remain from among the larger plurality of classes, the predetermined number of classes being the plurality of classes.

8. The method of claim 7, wherein the computing and merging are performed iteratively.

9. The method of claim 7, wherein the average mutual information comprises bi-gram mutual information.

10. The method of claim 7, wherein the merging is performed so as to maximize bi-gram mutual information between the plurality of classes.

11. The method of claim 1, wherein the plurality of classes relate to at least one of syntactic features, semantic features, and morphological features of the words in the set of word groupings.

12. The method of claim 1, wherein the set of class-based shrinkage features relate to at least one of syntactic features, semantic features, and morphological features of the words in the set of word groupings.

13. The method of claim 1, further comprising training a classifier using the set of shrinkage features.

14. The method of claim 1, wherein the set of class-based shrinkage features comprise a set of uni-gram features including c_j, w_j, and c_jw_j, wherein c_j denotes a jth class from among the plurality of classes, w_j denotes a jth word from the jth class, and c_jw_j denotes a joint feature pertaining to the jth class and the jth word.

15. The method of claim 14, wherein the set of class-based shrinkage features comprise a set of bi-gram features including c_j, c_{j−1}c_j, w_{j−1}c_j, w_j, c_jw_j, and w_{j−1}w_j, wherein
c_j denotes the jth class,
c_{j−1}c_j denotes a (jth−1) class from among the plurality of classes,
w_{j−1}c_j denotes a (jth−1) word from the (jth−1) class,
w_j denotes the jth word,
c_jw_j denotes the joint feature pertaining to the jth class and the jth word, and
w_{j−1}w_j denotes the (jth−1) word following by the jth word.

16. The method of claim 14, wherein the set of class-based shrinkage features comprise a set of bi-gram features including c_j, c_{j−1}c_j, w_{j−1}c_j, w_j, w_{j−1}c_jw_j, and c_jw_j, wherein
c_j denotes the jth class,
c_{j−1}c_j denotes a (jth−1) class from among the plurality of classes,
w_{j−1}c_j denotes a (jth−1) word from the (jth−1) class,
w_j denotes the jth word,
w_{j−1}c_jw_j denotes the (jth−1) word, the jth class and the jth word,
and c_jw_j denotes the joint feature pertaining to the jth class and the jth word.

17. The method of claim 14, wherein the set of class-based shrinkage features comprise a set of bi-gram features including c_j, c_{j−1}c_j, w_j, c_jw_j, and w_{j−1}w_j, wherein
c_j denotes the jth class,
c_{j−1}c_j denotes a (jth−1) class from among the plurality of classes,
w_j denotes the jth word,
c_jw_j denotes the joint feature pertaining to the jth class and the jth word, and
w_{j−1}w_j denotes a (jth−1) word from the (jth−1) class following by the jth word.

18. The method of claim 14, wherein the set of class-based shrinkage features comprise a set of bi-gram features including c_j, c_{j−1}c_j, w_j, c_jw_j, and w_{j−1}w_jc_j, wherein
c_j denotes the jth class,
c_{j−1}c_j denotes a (jth−1) class from among the plurality of classes,
w_j denotes the jth word,
c_jw_j denotes the joint feature pertaining to the jth class and the jth word, and
w_{j−1}w_jc_j denotes a (jth−1) word from the (jth−1) class, the jth word and jth class.

19. A system, comprising:
a word classifier for clustering each word in a set of word groupings of a given type into a respective one of a plurality of classes; and
a shrinkage feature extractor for selecting and extracting a set of class-based shrinkage features from the set of word groupings based on the plurality of classes,
wherein the set of class-based shrinkage features is specifically selected for an intended classification application.

20. The system of claim 19, wherein the set of class-based shrinkage features comprise a set of uni-gram features including c_j, w_j, and c_jw_j, wherein c_j denotes a jth class from among the plurality of classes, w_j denotes a jth word from the jth class, and c_jw_j denotes a joint feature pertaining to the jth class and the jth word.

21. The system of claim 20, wherein the set of class-based shrinkage features comprise a set of bi-gram features including c_j, c_{j−1}c_j, w_{j−1}c_j, w_j, c_jw_j, and w_{j−1}w_j, wherein
c_j denotes the jth class,
c_{j−1}c_j denotes a (jth−1) class from among the plurality of classes,
w_{j−1}c_j denotes a (jth−1) word from the (jth−1) class,
w_j denotes the jth word,
c_jw_j denotes the joint feature pertaining to the jth class and the jth word, and
w_{j−1}w_j denotes the (jth−1) word following by the jth word.

22. The system of claim 20, wherein the set of class-based shrinkage features comprise a set of bi-gram features including c_j, c_{j−1}c_j, w_{j−1}c_j, w_j, w_{j−1}c_jw_j, and c_jw_j, wherein
c_j denotes the jth class,
c_{j−1}c_j denotes a (jth−1) class from among the plurality of classes,
w_{j−1}c_j denotes a (jth−1) word from the (jth−1) class,
w_j denotes the jth word,
w_{j−1}c_jw_j denotes the (jth−1) word, the jth class and the jth word,
and c_jw_j denotes the joint feature pertaining to the jth class and the jth word.

23. The system of claim 20, wherein the set of class-based shrinkage features comprise a set of bi-gram features including c_j, c_{j−1}c_j, w_j, c_jw_j, and w_{j−1}w_j, wherein
c_j denotes the jth class,
c_{j−1}c_j denotes a (jth−1) class from among the plurality of classes,
w_j denotes the jth word,
c_jw_j denotes the joint feature pertaining to the jth class and the jth word, and
w_{j−1}w_j denotes a (jth−1) word from the (jth−1) class following by the jth word.

24. The system of claim 20, wherein the set of class-based shrinkage features comprise a set of bi-gram features including c_j, c_{j−1}c_j, w_j, c_jw_j, and w_{j−1}w_jc_j, wherein
c_j denotes the jth class,
c_{j−1}c_j denotes a (jth−1) class from among the plurality of classes,
w_j denotes the jth word,
c_jw_j denotes the joint feature pertaining to the jth class and the jth word, and
w_{j−1}w_jc_j denotes a (jth−1) word from the (jth−1) class, the jth word and jth class.

25. A computer readable storage medium comprising a computer readable program, wherein the computer readable program when executed on a computer causes the computer to perform the following:
cluster each word in a set of word groupings of a given type into a respective one of a plurality of classes; and
select and extract a set of class-based shrinkage features from the set of word groupings based on the plurality of classes,
wherein the set of class-based shrinkage features is specifically selected for an intended classification application.
